(19) United States
(12) Patent Application Publication
(10) Pub. No.: US 2003/0014503 A1
(43) Pub. Date: Jan. 16, 2003

(54) Method and apparatus for providing access of a client to a content provider server under control of a resource locator server

(76) Inventors: Arnaud Legout, Antibes (FR); Jakob Hummes, Juan Les Pins (FR)

Correspondence Address: Eric D. Cohen, Welsh & Katz, Ltd., 22nd Floor, 120 South Riverside Plaza, Chicago, IL, 60606, US

(21) Appl. No.: 10/184,437

(22) Filed: Jun. 28, 2002

(30) Foreign Application Priority Data
Jul. 12, 2001 (EP) 01401870.9

(51) Int. Cl. G06F 15/16

(52) U.S. Cl. 709/219

(57) ABSTRACT

A method provides client access to a content provider server under resource locator server control. The client connects to a network through a computer and accesses the resource locator server. The locator server provides to the computer a resource locator. The resource locator contains a digital signature representative of a right granted by the locator server to the client. The signature is computed based on a unique computer characteristic or on the computer connection to the network. The client computer accesses the provider server using the resource locator. The provider server checks the digital signature for the client connection to the network, and allows the client to access content according to the result of the checking. Further included are resource locator servers, content provider servers and computer program products are provided to implement this method. The processes avoid or makes very difficult link hijacking by the client.

### FIELD OF THE INVENTION

The invention is related to the field of communications over networks, and more particularly to authenticating and authorizing access of a user or client to a content provider server over a network, such as the World Wide Web.

### BACKGROUND

The World Wide Web (Web) uses the stateless hypertext transfer protocol (HTTP) to allow a client to request content from a server over a network. The HTTP protocol enables the transparent navigation from Web servers to Web servers through hypertext links. An hypertext link makes an association between a part of text and a URL (Uniform Resource Locator). A Web browser that runs on the machine of the client sends a HTTP GET message to a Web server running on the machine of the server. The address of the server is determined by a Uniform Resource Locator (URL) from the form “<protocol>://<server-address>/<path>/<content>”. The protocol HTTP is a client-server protocol, which uses a TCP network connection. How the data is interpreted by the browser depends on the MIME type of the returned data. FIG. 1 depicts the basic settings required by the client-server protocol: A client (100) and a server (104) are connected via a network (102); this network can also be multiple interconnected networks, for example the Internet. In FIG. 1, on the client machine (100) could run a Web browser, on the server machine a Web server.

In this simple scenario, as depicted in FIG. 1, where all content is delivered by the same server, a client can be authenticated, for example, via a simple login and password scheme over a secured connection (as example SSL or https). Once a client is authenticated, the server decides whether the client is authorized to access its content. However, there are instances where the content requested by a client is on a server separate from the server authenticating the client. Such a configuration is depicted in FIG. 2, were two separate servers 204 and 206 are depicted, in addition to the client computer system 200. The client may access either of the two servers over the network. A problem arises when the client accesses content provided by one of the servers—say server B—under the control of another server—say server A. In this case, the authentication scheme discussed above cannot be applied.

U.S. Pat. No. 5,870,546 is directed to the problem of determining the efficiency of advertising displayed to a client over a network; efficiency is measured as the number of times a client pursues the URL displayed in a server. A Web server system displaying the advertisement provides a client system with a URL reference to the advertised server. The URL reference is encoded with predetermined redirection and accounting data. On receipt by the advertised server, the URL reference is decoded and the accounting data is stored. This makes it possible for the advertised server to identify the number of URL displayed in the Web server system displaying the advertisement which are effectively pursued by the client. This document does not contemplate any use other than determining the efficiency of advertising, and notably does not prevent links from being copied by the client for accessing the advertised server without having first accessed the Web server system displaying the advertisement. Such copy of the link is called “link hijacking” in the rest of this description.

U.S. Pat. No. 5,963,915 discusses a method for performing trans-Internet purchase transactions. This document discusses the problem of “third party assumption of identity attack”. The problem is that a third party may be able to continue a secure session started by another client browser, if client authentication occurs only at the initiation of a secure session. This document only discusses security of purchase transactions.

In the system of U.S. Pat. No. 5,708,780, the user accesses the content server through a network. If the request is directed to a controlled page, the content server determines whether the URL contains an session identifier (SID). For example, a URL may be directed to a controlled page name “report”, such as “http://content.com/report”, that requires an SID. If no SID is present, as in this example, the content server sends a “REDIRECT” response to the browser of the user to redirect the user's initial request to an authentication server to obtain a valid SID. In the above example, a modified URL appended with an SID may be: “http://content.com/>SID!/report”. The preferred SID contains an 8-bit domain comprising a set of information files to which the current SID authorizes access, and a 22-bit user identifier. The SID further contains a digital signature which is a cryptographic hash of the remaining items in the SID and the authorized IP address which are encrypted with a secret key which is shared by the authentication and content servers.

Thus, the authentication server does not display to clients resource locators to content of the content provider server—but only receives redirected requests. Coding of the “set of information files” referenced by the 8-bit domain makes it necessary for the content server and authentication server to constantly update files protection schemes. In other words, any change in the content offered by the content provider makes it necessary to update the “set of information files” (unless the same system of rights is applied).

WO-A-00 73 876 discusses a proxy server that intercepts all Web traffic directed to a target server and adds profile information.

A number of cryptographic algorithms are disclosed in the prior art. One may notably mention:

Bellare, Mihir; Canetti, Ran; Kawczyk, Hugo: Keying Hash Functions for Message Authentication; in Advances in Cryptology—Crypto 96 Proceedings, Lecture Notes in Computer Science Vol. 1109, N. Koblitz ed., Springer-Verlag, 1996;

Rivest R., The MD5 Message-Digest Algorithm, RFC-1321, MIT LCS and RSA Data Security, Inc., April 1992;

Touch, J.: Performance Analysis of MD5, in Proceedings Sigcomm'95, Boston, pp. 77-86;

SECURE HASH STANDARD, National Institute of Standards and Technology, FIPS PUB 180-1, Apr. 17, 1995; and

P. Gutmann, Software Generation of Random Numbers for Cryptographic Purposes, in Proceedings of the 1998 Usenix Security Symposium, USENIX Association, 1998, pp. 243-257.

Thus, there is a need for a process for providing access of a client to a content provider server under control of a resource locator server, which does not allow link hijacking, or at least makes such link hijacking very difficult to carry out by the client.

### SUMMARY

In one embodiment, the process for providing access of a client to a content provider server under control of a resource locator server comprises:

the resource locator server displaying to clients resource locators to content of the content provider server;

the client connecting to a network through a computer system and accessing the resource locator server;

the resource locator server providing to the computer system a resource locator for accessing the content provider server, said resource locator containing a digital signature representative of a right granted by the resource locator server to the client for accessing the content provider server, said digital signature being computed based on at least one unique characteristic of the computer system or of the connection of the computer system to the network and based on an identifier of the content to be accessed;

the client computer system accessing the content provider server using said resource locator;

the content provider server checking the digital signature contained in the resource locator for the connection of the client to the network, and allowing the client to access content according to the result of this checking step.

The digital signature may be computed as a function of one or more of the following parameters: an address of the computer system of the client in the network, a unique identifier of the computer system of the client, the content to be accessed by the client, a client identification, time.

One may also provide a secret key to the resource locator server and to the content provider server, and compute the digital signature as a function of the secret key. This secret key may be generated using a cryptographically number generator.

In this case, the step of checking the digital signature by the content provider preferably comprises computing another digital signature using the secret key and comparing the other digital signature with the digital signature contained in the resource locator.

For the computation, it is advantageous to use a cryptographic hash function, and particularly a cryptographic hash function selected among MD5, SHA-1, MD2, MD4, RIPEMD-128 and RIPEMD-160. One may also use a cryptographic hash function of a string comprising at least one of the address of the computer system of the client in the network, a unique identifier of the computer system of the client, a function of the content to be accessed by the client, a client identification, and time. If a secret key is provided to the resource locator server and to the content provider server, and the string may comprise the secret key.

In one embodiment of the invention, the content provider server is a content delivery network comprising at least two servers. One may then provide a secret key to the resource locator server and to one of the servers, and provide another secret key to the resource locator server and to another one of said at least two servers. It is advantageous that the secret key for one of the two servers be computed using a cryptographic hash function of a main secret key and of an address of said one server in the network.

The invention further provides a process for providing a resource locator to a client, in a resource locator server connected to a network, comprising:

displaying to clients resource locators;

receiving from the network an access request for one of the displayed resource locators, originating from a computer system connecting the client to the network;

providing to the network toward the computer system a resource locator, said resource locator containing a digital signature representative of a right granted by the resource locator server to the client for accessing resource located by said resource locator, said digital signature being computed based on at least one unique characteristic of the computer system or of the connection of the computer system to the network and based on an identifier of the content to be accessed.

The computation may be carried out as stated above

The invention further provides a process for providing access of a client to a content, in a content provider server connected to a network, comprising:

receiving from the network an access request originating from a computer system connecting the client to the network and containing a digital signature;

checking the digital signature contained in the resource locator according to at least one unique characteristic of the computer system or of the connection of the computer system to the network received in said request, and according to an identifier of the content requested by the client; and

allowing the client to access content according to the result of this checking step.

The step of checking the digital signature may comprise computing another digital signature and comparing said another digital signature with the digital signature contained in said resource locator.

If the access request contains an address of the computer system of the client in the network, the other digital signature may be computed as a function of the address. The access request may also contain a unique identifier of the computer system of the client and the other digital signature is then computed as a function of the unique identifier. One could also compute the other digital signature as a function of the content to be accessed by the client, as a function of a client identification, as a function of time, or as a function of a secret key provided to the server.

For computing the other digital signature, one may proceed as discussed above.

The invention further provides a resource locator server, comprising

a connection to a network,

a program carrying out the process given above.

It also provides a content provider server, comprising

a connection to a network;

a program carrying out the process given above.

In this case, the content provider server may be a content delivery network comprising at least two servers, and possible a redirection unit. In case a redirection unit is provided, it would have a program selecting one of the servers of said content delivery network and carrying out this process.

The invention also provides a computer program product embodied in a computer-readable medium for providing a resource locator to a client, in a resource locator server connected to a network, the computer program product comprising:

computer readable program code means for receiving from the network an access request originating from a computer system connecting the client to the network;

computer readable program code means for providing to the network toward the computer system a resource locator, said resource locator containing a digital signature representative of a right granted by the resource locator server to the client for accessing resource located by said resource locator, said digital signature being computed based on at least one unique characteristic of the computer system or of the connection of the computer system to the network and based on an identifier of the resource.

Last, the invention also provides a computer program product embodied in a computer-readable medium for providing access of a client to a content, in a content provider server connected to a network, the computer program product comprising:

computer readable program code means for receiving from the network an access request originating from a computer system connecting the client to the network and containing a digital signature;

computer readable program code means for checking the digital signature contained in the resource locator according to at least one unique characteristic of the computer system or of the connection of the computer system to the network received in said request, and according to an identifier of the content to which access is requested; and

computer readable program code means for allowing the client to access content according to the result of this checking step.

### BRIEF DESCRIPTION OF THE DRAWINGS

The features of the present invention which are believed to be novel are set forth with particularity in the appended claims. The invention, together with further objects and advantages thereof, may best be understood by reference to the following description in conjunction with the accompanying drawings.

FIG. 1 shows a client-server system that is connected via a network;

FIG. 2 shows a similar system with two servers;

FIG. 3 shows a system where one of the servers of FIG. 2 is replaced by a content delivery network with a redirection unit;

FIG. 4 shows a flowchart of a process according to the invention, as executed by a server from which the user or client gets a resource locator; and

FIG. 5 shows a flowchart of a process according to the invention, as executed by a server that serves the requested content to a client when requested with the resource locator.

### DETAILED DESCRIPTION

FIG. 2 shows a client server system connected via a network with two servers. One of the servers—server B in the rest of this example—is a content provider server. The other server—server A in this example—is a resource locator server providing to the client a resource locator for accessing server B.

For instance, let A be a content aggregator (for example a Web portal) that has a contractual relation with B, a content provider. A offers, via its Web site, links to content items that are served by a server (for example a Web server, an ftp server, or a streaming media server) operated by B. Since A and B have a contractual relation, they want to prevent that any non authorized third-party C can also offer links to the content provided by B. In the Internet today, C could copy the links from A's Web pages and use them in its own Web pages, this being a form of “link hijacking”. The links could also be copied by a client for later access to the content provided by B, or for forwarding to another client. This is another form of link hijacking.

The invention solves this link hijacking problem by introducing a digital signature in the resource locator provided by the resource locator server A to the client, for accessing the content provider server B. The digital signature is representative of a right granted by the resource locator server A to the client for accessing the content provider server B; it is computed based on at least one unique characteristic of the computer system or of the connection of the computer system to the network. It is further computed based on an identifier of the content to which access is requested. This identifier may have any format. It may be the URI (the path information of a URL), or any other information representative of the information to be accessed.

Thereafter, the client computer system accesses the content provider server using the resource locator; the content provider server B may then check the digital signature contained in the resource locator used by the client, and may allow the client to access content according to the result of this checking step.

This prevents any form of link hijacking. Assume the resource locator is copied by the client, and is provided to a third party. The digital signature is computed based on at least one unique characteristic of the computer system or of the connection of the computer system to the network. Thus, the content provider server B may identify, upon receiving the resource locator from the third party, that the resource locator was transmitted by a party that does have the required unique characteristic. The content provider server may therefore refuse to serve the request of the third party.

Thus, together with known Web server security settings—SSL, https or any other scheme for recognizing the client—A can thus offer subscription based content access to B's content or pay-per-view models, without requiring that B also uses end-to-end security. This is especially useful, if the contents served by B are large files or are streamed over connectionless protocols (for example audio/video content streamed by media servers such as Microsoft's Windows Media Server or RealNetwork's RealServer). Furthermore, in the preferred embodiment discussed below, the invention requires only the exchange of private keys between A and B, once the service is initialized. Afterwards, no direct communication between the servers A and B are needed.

Since the digital signature is computed based on an identifier of the information to which access is requested, there is no need to continuously update the information protection scheme between the content server and the authentication server. In the simplest embodiment, the identifier is the name of the resource to be accessed. This provide univoque identification of the resource, without having to implement a common protection scheme in the content server and in the authentication server.

On the contrary, in the SID system proposed in U.S. Pat. No. 5,708,780, there is a need to have at least some communication between the servers whenever a protection domain changes. The authentication server must know the protection domains that the content server can server to admit or deny access. Thus, at any time, both the authentication server and the content server must have the same notion of protection domain.

The present invention, since it does not require this communication, is easier to deploy and to extend. It even works with contents (or protection domain) that have not been known in the beginning.

In addition, U.S. Pat. No. 5,708,780 needs the notion of protection domain and is limited to a fixed number of protection domains (in the example 8 bit=256 domains). Whatever the coding scheme, there will be always a limit to the number of protection domains. Thus, together with the needed communication between the content server and the authentication server, this leads to a non-scalable system, especially if domains are often changed.

The present invention is not limited since the identifier, which is secured by the digital signature can have arbitrary length and form. Since the invention does not require any communication between the servers, it is scalable—i.e. it is possible to add more and more content servers without any problem, and without having to constantly update the information provided to the authentication server.

In the preferred embodiment, the invention uses a scheme based on a cryptographic hash function and on the use of a secret key. The strength of the scheme relies on the fact that, given a secret key K and a cryptographic hash function H, it is in practice not possible with computational methods to find an m′ such that H(K+m+K)=H(m′) without the knowledge of K, and it is in practice not possible to find with computational methods K based on the knowledge of m and of H(K+m+K); this is discussed in Bellare et al. Should a mathematical method be known in the future that breaks the prior scheme, it is always possible within this invention to change the parameters within the cryptographic hash function to strengthen its resistance against attacks; an example would be the use of HMAC as described in Bellare et al. It is also possible to a use another newer hash function with stronger properties; new and secure cryptographic hash functions are regularly published.

A preferred embodiment of the invention is now described.

Initialization

First a secret key K_{Web} is generated. The key is preferably generated with a cryptographically strong key generator. That means that it is not possible from an arbitrary sequence of keys to find the next key in the sequence. Implementations of cryptographically strong key generators are commercially available and a description of their implementation can be found in literature, for example in the reference of P. Gutman given above. K_{Web} is distributed to A and B.

2. Authentication Process

Let H be a cryptographic hash function, for example MD5 (see Rivest reference), SHA-1 (see Secure Hash Standard), or any other. In the preferred embodiment, we choose MD5 as hash function, since it is for the moment the best compromise between security and speed of computation (see Touch reference). Moreover, MD5 is publicly available. The output of the MD5 hash function is a 128 bits string whatever the input is.

K_{Web} is a secret key shared by A's Web server (204) and by B's server (206).

A viewer first connects to A's Web server. By a given process that is independent of the described invention, the web server may identify this viewer as authorized to connect to the web server. Examples to implement this given process use SSL, https, or other security settings known per se.

All Web pages that contain links (URLs) to the content served by B's server are deployed as dynamic Web pages, that means that the Web pages are calculated in the moment the viewer accesses them. At least, the resource locator is dynamically computed, so that the digital signature is computed based on the unique characteristic of the client computer system or of the client connection; the rest of the pages may be static. In the moment the viewer accesses such a Web page, the method of this invention starts its authentication process.

Before the Web page is delivered to the viewer, the authentication method which is integrated with A's Web server (for example using ASP, JSP, or other techniques to generate dynamic Web pages) replaces each link to B's content, with a new link that contains the original link plus optionally additional data (for example a unique user identifier and a timestamp) plus a digital signature. The signature is calculated by a cryptographic hash function, which takes as input this link and the additional data and a unique identifier of the client system or of its connection to the network and the secret key K_{Web}. In this description, the IP address of the connection of the client system to the network is used as unique identifier. The viewer's IP address is known from the TCP connection with the Web server and is accessible from the implementation of the authentication method. For simplicity, the rest of this section describes the method without any additional data; the usefulness of additional data is then explained later in describing alternative use cases.

For example, let the authentication being implemented as Java Bean (“urlAuthenticator”), used by a Java Server Page (JSP) to generate a new authenticated link.

The viewer sends an HTTP GET request to A's Web server to see a Web page that contains the links to B's content (400). The following JSP portion is then executed by the Web server to generate a new link for the each link that should be authenticated:

<a href=″<%=urlAuthenticator.generateLink(request.getRemoteHost( ),

“http://www.b.com/1.asx”) %>″>Click here</a>

which produces for example the following HTML code:

<a href=″

http://www.b.com/1.asx?8978a19bc1c3a98d6467c603e1be299c″>Click

here</a>

where the part behind the “?”is the digital signature for this content and the IP address of the requesting viewer.

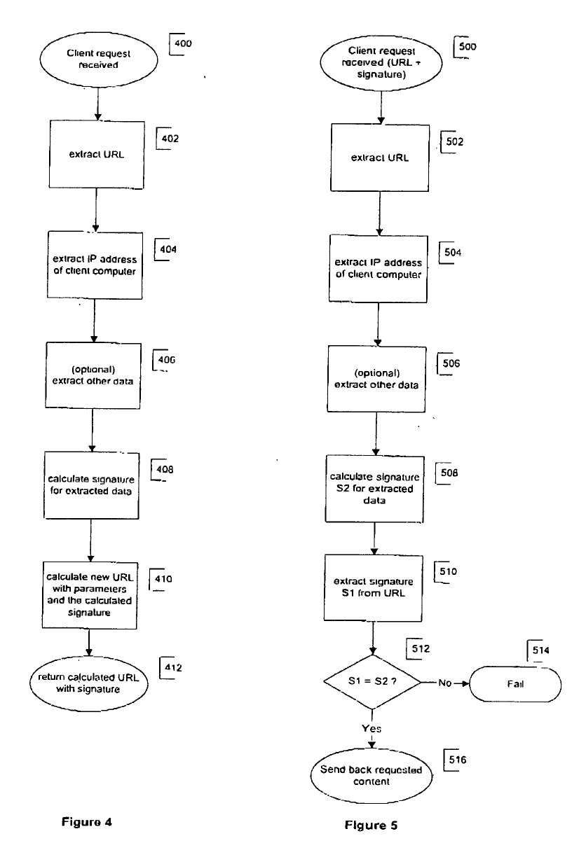

The computational steps of the method implemented within A's Web server are depicted in the flowchart in FIG. 4. Each link is computed as soon as the page is requested (400). The method first extracts the URL to B's content (402), given in the JSP example above as parameter to the method's implementation (generateLink( )). The IP address of the viewer's computer is extracted (404) and also passed to the method (request.getRemoteHost( )). In this example no additional data is passed to the method, which would be step (406).

The method then computes the digital signature (408) as follows:

S₁=H(K_{Web}+IP_{V}+contentid+K_{Web})

where H( ) is the cryptographic hash function operating on a string, K_{Web} is the secret key shared by A's Web server and by B's server, IP_{V} is the IP address of the viewer, contentid is an identifier of the requested content (“1” in this example), and “+” denotes the concatenation of strings. S₁ must be encoded to be a valid string inside a URL; in this example the value of S₁ is encoded as hexadecimal representation in a string, which guarantees that only characters of “0-9” and “a-e” are used, and that the total length is exactly 32 characters long in the case that MD5 is used as hash function.

In the last step the original URL and the signature are concatenated to form a new valid URL to the requested content (410). This URL is then the output of the executed method (412) and inserted into the Web page sent back to the viewer's browser.

At this point it is fundamental to understand that the security of this embodiment of the invention relies on the fact that the secret key K_{Web} must never be given to a non-trusted third party.

When the viewer selects this generated link, the viewer's application (for example the Web browser or a plugin for the specified media-type if the URL denotes another protocol than the HTTP protocol) connects to B's server and requests the URL together with the signature (500).

B's server passes the received URL (which would be http://www.b.com/1.asx?8978a19bc1c3a98d6467c603e1be299c to continue the previous example) together with the IP address IP_{V′} (504) from the connection with the viewer to B's implementation of the authentication method. The authentication method extracts from the URL the contentid′ (502) and S₁ (510).

Finally, the authentication method computes S₂=H(K_{Web}+IP_{V′}+contentid′+K_{Web}) (508) and checks whether S₂ is equal to S₁ (512).

If S₂ is equal to S₁, the requested content is served by B's server (516), otherwise the operation is executed that is considered as the right response for an unauthorized user (514), for example a “Not authorized” HTTP error is returned.

If S₂ is equal to S₁, it is guaranteed that the viewer of the A's Web page has the same IP address as the viewer that accesses B's server, that means IP_{V′}=IP_{V}; the viewers are thus considered as being the same. Additionally, it is guaranteed that this viewer was authorized by A's Web server to view the requested content, since the contented and contentid'are the same. Since only A's and B'S server share the secret key K_{Web}, it is guaranteed that the viewer must have obtained the URL by prior accessing A's Web page and cannot have obtained this link from an unauthorized source.

The process has the following advantages. Two providers, A and B, can ensure that content that B serves is only available to clients authorized by A. Only an initial secret key must be exchanged between A and B; it is not needed to know all users that will be authorized by A in advance; i.e. A can admit later on more and other users to access B's content.

Also, as discussed above, A does not need to know in advance all content that is served on B.

The described method does not need a real-time communication between the server that authenticates the user the first time (A) and the server that serves the content for the authorized user (B).

Furthermore, the connection between the user and the server that serves the content does not need to be secured. This is especially important for streaming content, which is served via UDP packets.

The described method does not need that the original server communicates in real-time with one or several content servers. This leads to a higher performance of the described method for the authentication process. The described method is easier to implement and does not depend on network conditions between the original server and the content servers.

The method has advantages especially if several content servers can serve the same content, since the secret key can be installed on each replica server; for example if the content was replicated to ensure higher availability or faster downloads.

This method works for all forms of link hijacking : it works if a third party copies links from A, but also if an authorized user of A willfully discloses the links to B's content.

The method also scales with the number of content servers. It may be used in a variety of related products. Examples are:

content distribution networks that support subscription models or pay-per-view models.

allowing a content provider to publish content on the network and to allow partners to offer access to this content to their customers, but not to others.

The invention is not limited to the preferred embodiment exemplified above. For instance, the process was discussed above for dynamic Web pages. It also applies to static web pages, provided the digital signature is computed according to one unique characteristic of the client computer system or connection. The example uses a cryptographic hash function. Other means may be used for computing the digital signature—basically any function that is hard enough to reverse for the client, but may be easily computed by both the resource locator server and the content provider server. Functions other than cryptographic functions may not make it necessary to provide a secret key to the resource locator server and to the content provider server.

The example uses as a unique characteristic the IP address; as discussed below, one may use another unique characteristic; generally speaking, the characteristic should be unique to avoid link hijacking, and is preferably difficult to alter by the client.

In another embodiment of the invention, additional data can be passed from A's Web server to B's server and it can be guaranteed that the viewer cannot alter this additional data. As example the following can be useful in a pay-per-view system for streaming audio/video transmissions:

A offers access to streaming transmission served by B's server, but wants additionally to ensure that the viewer cannot use the link obtained from A's Web page multiple times. A has also an agreement with B, that B provides A with the data how long a particular viewer has accessed a stream. To do this, A deploys a secured Web server, where each viewer authenticates himself first via a login and password scheme. After the viewer is authenticated and authorized to access the Web page, a unique user identification userid is assigned to this viewer. Additionally, the time is obtained, when the viewer selects a link to a stream.

The URL that is computed by the described method is composed of the original URL plus the time plus the userid and followed by the signature as described above, but also computed above the additional data. The URL has thus a form similar to:

href=”http://www.b.com/1.asx?userid_time_S”,

where S=H(K_{Web}+IP_{V}+userid+contentid+time+K_{Web}).

B's server extracts from the URL the time and userid and refuses access to the stream, if the difference between the time in the URL and the actual time is greater than a given threshold (for example 10 minutes). This requires that the clocks between A's and B's servers are loosely synchronized (less than a 10 minutes difference) and that the time in the URL is encoded in an agreed timezone format, which is known by both servers (for example: Universal Time, UTC). B uses the obtained userid to report to A, how long the viewer has accessed the stream. The authentication method guarantees that the viewer cannot alter neither the time nor the userid to access the content from B.

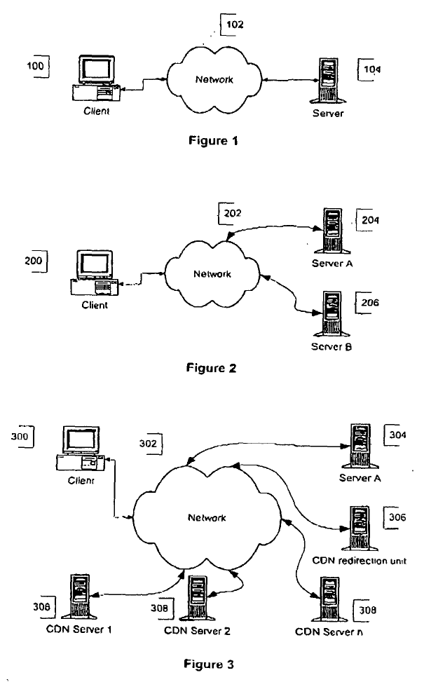

In a similar scenario, B operates a content delivery network (CDN), cfg. FIG. 3. In a CDN, the content is replicated on multiple servers. The described method works as described above, only the secret key K_{Web} is given to all servers within the CDN.

If the CDN uses application level redirections, the described method can be chained. The secret key K_{Web} is shared between A's Web server (304) and the redirection unit (306) of the CDN. The redirection unit of the CDN uses a different key K_{CDN} to compute a new URL that is given back to the viewer. This secret key K_{CDN} is shared between the redirection unit and all the content servers (308) of the CDN. If the viewer should be restricted to access the stream only from the server chosen by the redirection unit, a unique identifier (for example the IP address of the chosen content server) can be encoded within the computed URL and signature. Before a content server within the CDN delivers the content to the viewer, the server tests, if it has been selected by the redirection unit by comparing the unique identifier in the URL with its locally known unique identifier.

In the example of the cryptographic function, the security of the process depends on the fact that an unauthorized person does not know the secret key. Therefore it is preferable to store the secret key on each server in a way that no unauthorized person has access to it. In a huge distributed system consisting on hundreds or thousands of servers (for example a huge CDN), a different secret key can be assigned to each server, although this complicates the initialization phase, and the redirection unit must know, which server will serve the requested content for a particular request. However, the computation of a cryptographically strong secret key requires many CPU cycles, and the secret keys must be stored in a table by the redirection unit. In order to facilitate this process the following method can be taken:

The redirection unit first has a main secret key K_{RU} generated with a cryptographically strong key generator.

Then, for each CDN server CSⁱ (IP address: IP_{CS}ⁱ), a secret key K_{CS}ⁱ=H(K_{RU}+IP_{CS}ⁱ+K_{RU}) is generated and on each CDN server CSⁱ the secret key K_{CS}ⁱ is stored. Each time the redirection unit selects the CDN server CSⁱ, the redirection unit computes the signature S₂ with the computed key K_{CS}ⁱ instead of K_{CDN}.

In case a key K_{CS}ⁱ is stolen, the thief can access to any content on the CDN server CSⁱ, but does not have access to the other CDN servers. Moreover, with the stolen key, it is not computationally possible to discover the main key K_{RU}.

The described invention uses in its preferred embodiment the IP address of the requester, since it is technically very difficult to masquerade its own IP address and being able to receive IP packets from a source in the Internet. However, in some cases the IP address is not the best authentication method. Firewalls, Web proxies and caches can intercept a request and formulate a new request originating at the interceptor. Alternatively, a different unique identifier can be taken by the described invention to replace the IP address in the method description; candidates for these unique identifiers are among others: the global unique identifier (GUID) supplied by some browsers and media players or the CPU serial number of the requester's machine. The main problem with those unique identifiers is that they are in theory easier to masquerade than the IP address. The other proposed unique identifiers can also be taken in addition to the IP address. It is possible to use more than one unique identifier.

The description of the alternative embodiment within a CDN describes, how a central redirection unit can produce a new URL with a new digital signature. Within this invention, it is also possible that the redirection unit generates a document (HTML, XML, ASX, SMILE, or other format) with links that are calculated as described for the resource locator server. In general, the described invention can be chained.

The description of the alternative embodiment within a CDN describes, how a central redirection unit can produce a new URL with a new digital signature. Within this invention, it is also possible that no central redirection unit for a CDN exist, but that the redirection is made transparently on the network path (e.g. through a Router or Layer 4-7 switch). As example, in such a scenario a Layer 4 switch would redirect all HTTP requests to an HTTP cache for all end-users that are on this network path. The pages with the links generated by the resource location server are marked as non-cacheable; when the viewer requests the content from the content server, the cache uses the same method as the content server to check the digital signature and grants the access to the content in behalf of the content server. This implies, of course, that the cache implements the described invention. However, the redirection unit (in this example: Layer 4 switch) does not use the described method.

The description given above shows the process as a whole. Of course, the process is carried out independently at the resource locator server and at the content provider server—whatever his form. It is possible to provide a computer program coding the process carried out at the resource locator server, and a separate computer program coding the process carried out at the content provider server.

Specific embodiments of a method and apparatus for providing access of a client to a content provider server under control of a resource locator server according to the present invention have been described for the purpose of illustrating the manner in which the invention may be made and used. It should be understood that implementation of other variations and modifications of the invention and its various aspects will be apparent to those skilled in the art, and that the invention is not limited by the specific embodiments described. It is therefore contemplated to cover by the present invention any and all modifications, variations, or equivalents that fall within the true spirit and scope of the basic underlying principles disclosed and claimed herein.

What is claimed is

1. A method for providing access of a client to a content provider server under control of a resource locator server, comprising the steps of:
the resource locator server displaying to clients resource locators to content of the content provider server;
the client connecting to a network through a computer system and accessing the resource locator server;
the resource locator server providing to the computer system a resource locator for accessing the content provider server,
said resource locator containing a digital signature representative of a right granted by the resource locator server to the client for accessing the content provider server, said digital signature being computed based on at least one unique characteristic of the computer system or of the connection of the computer system to the network and based on an identifier of the content to be accessed;
the client computer system accessing the content provider server using said resource locator;
the content provider server checking the digital signature contained in the resource locator for the connection of the client to the network, and allowing the client to access content according to the result of this checking step.

2. The method of claim 1, further including the step of computing the digital signature as a function of an address of the computer system of the client in the network.

3. The method of claim 1, further including the step of computing the digital signature as a function of a unique identifier of the computer system of the client.

4. The method of claim 1, further including the step of computing the digital signature as a function of a client identification.

5. The method of claim 1, further including the step of computing the digital signature as a function of time.

6. The method of claim 1, further comprising the step of providing a secret key to the resource locator server and to the content provider server, and computing the digital signature as a function of the secret key.

7. The method of claim 6, wherein the step of providing a secret key further includes generating the secret key using a cryptographically number generator.

8. The method of claim 6, wherein the step of checking the digital signature by the content provider further includes computing another digital signature using the secret key and comparing said another digital signature with the digital signature contained in said resource locator.

9. The method of claim 1, wherein the step of computing includes computing a cryptographic hash function.

10. The method of claim 2, wherein the step of computing includes computing a cryptographic hash function of a string having at least one of the address of the computer system of the client in the network, a unique identifier of the computer system of the client, a function of the content to be accessed by the client, a client identification, and time.

11. The method of claim 10, further including the step of providing a secret key to the resource locator server and to the content provider server, and wherein said string includes the secret key.

12. The method of claim 11, wherein said cryptographic hash function is a keyed cryptographic hash function.

13. The method of claim 9, wherein the cryptographic hash function is selected from the group consisting of MD5, SHA-1, MD2, MD4, RIPEMD-128 and RIPEMD-160.

14. The method of claim 1, wherein the content provider server is a content delivery network comprising at least two servers.

15. The method of claim 14, further comprising the step of providing a secret key to the resource locator server and to one of said at least two servers, and providing another secret key to the resource locator server and to another one of said at least two servers.

16. The method of claim 15, wherein a secret key for one of said at least two servers is computed using a cryptographic hash function of a main secret key and of an address of said one server in the network

17. A method for providing a resource locator to a client, in a resource locator server connected to a network, comprising the steps of:
displaying to clients resource locators;
receiving from the network an access request for one of the displayed resource locators, originating from a computer system connecting the client to the network;
providing to the network toward the computer system a resource locator, said resource locator containing a digital signature representative of a right granted by the resource locator server to the client for accessing resource located by said resource locator, said digital signature being computed based on at least one unique characteristic of the computer system or of the connection of the computer system to the network and based on an identifier of the content to be accessed.

18. The method of claim 17, further including the steps of computing the digital signature as a function of an address of the computer system of the client in the network.

19. The method of claim 17, further including the step of computing the digital signature as a function of a unique identifier of the computer system of the client.

20. The method of claim 17, further including the step of computing the digital signature as a function of a client identification.

21. The method of claims 17, further including the step of computing the digital signature as a function of time.

22. The method of claims 17, further including the step of computing the digital signature as a function of a secret key.

23. The method of claim 17, wherein the step of computing comprises computing a cryptographic hash function.

24. The method of claim 17, wherein the step of computing comprises computing a cryptographic hash function of a string comprising at least one of the address of the computer system of the client in the network, a unique identifier of the computer system of the client, a function of the resource, a client identification, and time.

25. The method of claim 24, wherein the string further comprises a secret key.

26. The method of claim 25, further comprising the step of generating said secret key using a cryptographic number generator.

27. The method of claim 24, wherein said cryptographic hash function is a keyed cryptographic hash function.

28. The method of claim 27, wherein the cryptographic hash function is selected from the group consisting of MD5, SHA-1, MD2, MD4, RIPEMD-128 and RIPEMD-160.

29. The method of claim 22, wherein said secret key is a function of a server address contained in said resource locator.

30. The method of claim 29, wherein said secret key is a cryptographic hash function of a server address contained in said resource locator.

31. A method for providing access of a client to a content, in a content provider server connected to a network, comprising:
receiving from the network an access request originating from a computer system connecting the client to the network and containing a digital signature;
checking the digital signature contained in the resource locator according to at least one unique characteristic of the computer system or of the connection of the computer system to the network received in said request, and according to an identifier of the content requested by the client; and
allowing the client to access content according to the result of this checking step.

32. The method of claim 31, wherein the step of checking the digital signature comprises computing another digital signature and comparing said another digital signature with the digital signature contained in said resource locator.

33. The method of claim 32, wherein said access request contains an address of the computer system of the client in the network and wherein said another digital signature is computed as a function of the address.

34. The method of claim 32, wherein said access request contains a unique identifier of the computer system of the client and wherein said another digital signature is computed as a function of the unique identifier.

35. The method of claim 32, wherein said access request contains a client identification and wherein said another digital signature is computed as a function of said client identification.

36. The method of claim 32, wherein said another digital signature is computed as a function of time.

37. The method of claim 32, wherein the server is provided with a secret key, and wherein said another digital signature is computed as a function of said secret key.

38. The method of claim 32, wherein the step of computing another digital signature comprises computing a cryptographic hash function.

39. The method of claim 32, wherein the step of computing said another key comprises computing a cryptographic hash function of a string comprising at least one of the address of the computer system of the client contained in said request, a unique identifier of the computer system of the client contained in said request, a function of the content to be accessed by the client, a client identification contained in said request, and time.

40. The method of claim 38, wherein the cryptographic hash function is selected from the group consisting of MD5, SHA-1, MD2, MD4, RIPEMD-128 and RIPEMD-160.

41. A resource locator server, comprising:
a connection to a network,
a program carrying out the method of claim 17.

42. A content provider server, comprising:
a connection to a network;
a program carrying out the method of claim 31.

43. The server of claim 42, wherein the content provider server is a content delivery network comprising at least two servers.

44. A computer program product embodied in a computer-readable medium for providing a resource locator to a client, in a resource locator server connected to a network, the computer program product comprising:
computer readable program code means for receiving from the network an access request originating from a computer system connecting the client to the network;
computer readable program code means for providing to the network toward the computer system a resource locator, said resource locator containing a digital signature representative of a right granted by the resource locator server to the client for accessing resource located by said resource locator, said digital signature being computed based on at least one unique characteristic of the computer system or of the connection of the computer system to the network and based on an identifier of the resource.

45. A computer program product embodied in a computer-readable medium for providing access of a client to a content, in a content provider server connected to a network, the computer program product comprising:
computer readable program code means for receiving from the network an access request originating from a computer system connecting the client to the network and containing a digital signature;
computer readable program code means for checking the digital signature contained in the resource locator according to at least one unique characteristic of the computer system or of the connection of the computer system to the network received in said request, and according to an identifier of the content to which access is requested; and
computer readable program code means for allowing the client to access content according to the result of this checking step.
